(19) United States
(12) Patent Application Publication
(10) Pub. No.: US 2014/0020102 A1
(43) Pub. Date: Jan. 16, 2014

(54) INTEGRATED NETWORK ARCHITECTURE

(71) Applicant: Infosys Limited, Bangalore (IN)

(72) Inventors: Karthik Srinivasan, Bangalore (IN); Rajar Arya, Meerut (IN)

(73) Assignee: Infosys Limited

(21) Appl. No.: 13/940,152

(22) Filed: Jul. 11, 2013

(30) Foreign Application Priority Data
Jul. 16, 2012 (IN) 2863/CHE/2012

(51) Int. Cl. H04L 12/24; H04L 29/06

(52) U.S. Cl. CPC H04L 41/00; H04L 63/1408
USPC 726/23; 709/223; 709/224

(57) ABSTRACT

An integrated network architecture can provide information centric and Internet Protocol processing. The integrated network architecture can comprise a packet core that supports packet processing for information centric network packets and Internet Protocol packets, a service core that comprises services supporting a plurality of different operation modes that can be enabled and disabled independently (including an access operation mode, an edge operation mode, a core operation mode, and a proxy operation mode), a client management service that supports network client mobility between network devices, and/or a cache management service that supports cache lookup and cache update services.

### BACKGROUND

Currently, the Internet is primarily a point-to-point network where information is identified by its location on the network. For example, information can be identified using a uniform resource locator (URL) which includes a host name and domain name (resolving to an Internet Protocol (IP) address) and a path to the information.

The point-to-point nature of the Internet leads to inefficiencies in content delivery. For example, if many network clients are trying to access a particular piece of content at a particular location at the same time, the resulting congestion can cause access to be slow or unavailable.

Various technologies have been developed to provide an information centric alternative to the traditional point-to-point networking paradigm of the Internet. Some solutions have been developed to provide a separate overlay of information centric technologies on top of the IP networking technology of the Internet. However, such information centric overlay technologies do not provide an integrated, configurable, and expandable solution providing efficient processing of both information centric and traditional IP traffic.

Other approaches to an information centric network (e.g. Named Data Networking (NDN), Publish-Subscribe Internet Routing Protocol (PSIRP)) attempt to take a “clean slate” approach looking to completely re-design the current Internet. They do not address how the transition from the current Internet to an information centric Internet can be done effectively and with minimal disruption. Also, an information centric view can break the behavior of applications that need to be end point centric (e.g. real-time communications and transaction based systems).

Therefore, there exists ample opportunity for improvement in technologies related to a network architecture providing information centric processing of information, while at the same time exploiting the power of current IP-based Internet technology in areas where it still remains a good fit.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Techniques and tools are described for providing an integrated network architecture that combines information centric and Internet Protocol processing. For example, the integrated network architecture (INA) can provide efficient processing for information centric network traffic and IP network traffic in a variety of network roles.

For example, an integrated network architecture, implemented at least in part by a network device, can be provided for providing information centric and Internet Protocol (IP) processing. The integrated network architecture can comprise a packet core, where the packet core supports packet processing for information centric network (ICN) packets and IP packets, a service core, where the service core comprises services supporting a plurality of different operation modes, where the plurality of different operation modes comprise an access operation mode, an edge operation mode, a core operation mode, and a proxy operation mode, and where the service core supports independent enabling or disabling of each of the plurality of operation modes, a client management service that supports network client mobility between network devices, and a cache management service that supports cache lookup and cache update services.

As another example, an integrated network architecture, implemented at least in part by a network device, can be provided for providing information centric and Internet Protocol processing within a combined information centric network (ICN) and IP network. The integrated network architecture can comprise a packet core that supports packet processing for information centric network packets and IP packets, a service core that comprises services supporting a plurality of different operation modes (e.g., an access operation mode, an edge operation mode, a core operation mode, and a proxy operation mode), where the service core supports independent enabling or disabling of each of the plurality of operation modes, a client management service that supports client mobility between network devices, a cache management service that supports cache lookup and cache update services, a routing service that supports routing for ICN packets and IP packets, a translation service that supports translating between ICN information and IP information, a link management service that supports communication between network devices of the combined ICN and IP network, a management and monitoring service that provides for managing and monitoring the integrated network architecture, and/or an application services component that provides services comprising search services and application specific routing services.

As described herein, a variety of other features and advantages can be incorporated into the technologies as desired.

### BRIEF DESCRIPTION OF THE DRAWINGS

FIG. 1 is a block diagram of an example integrated network architecture comprising a service core and a packet core.

FIG. 2 is a diagram of example network domains, including INA domains and IP domains.

FIG. 3. is a block diagram of an example integrated network architecture comprising multiple layers.

FIG. 4 is a diagram of an example packet core of an integrated network architecture.

FIG. 5 is a diagram depicting example elements and operation of a service core.

FIG. 6 is a diagram showing application specific extensions.

FIG. 7 depicts a definition for a client management service in a specific implementation.

FIG. 8 depicts a definition for a link management service in a specific implementation.

FIG. 9 depicts a definition for a routing service in a specific implementation.

FIG. 10 depicts a definition for a translation service in a specific implementation.

FIG. 11 depicts a definition for a cache management service in a specific implementation.

FIG. 12 is a diagram of an exemplary computing system in which some described embodiments can be implemented.

FIG. 13 is an exemplary cloud computing environment that can be used in conjunction with the technologies described herein.

### DETAILED DESCRIPTION

### Example 1—Overview

The following description is directed to techniques and solutions for integrating information centric networking (e.g., NDN/PSIRP—Named Data Networking/Publish-Subscribe Internet Routing Protocol) with the current Internet architecture, which is based on Internet Protocol (IP) networking. For example, an integrated network architecture can be provided that integrates processing of information centric packets and IP packets. The integrated network architecture can be implemented by a network device (e.g., a router or other type of network device). The integrated network architecture can be used to provide information centric networking services while still providing compatibility with existing IP-based networking services. Furthermore, the integrated network architecture can provide both information centric networking services and IP-based networking services in a flexible and efficient manner.

In some implementations, an integrated network architecture provides core networking functions, including content delivery, mobility of client devices, and security.

In some implementations, an integrated network architecture provides at least a packet core and a service core. The packet core can support packet processing for information centric network (ICN) packets and Internet Protocol (IP) packets. The service core can support a plurality of different operation modes. For example, the operation modes can comprise an access operation mode, an edge operation mode, a core operation mode, and a proxy operation mode. Furthermore, the integrated network architecture can support independent enabling and disabling of the various operation modes. For example, a network device that implements the integrated network architecture can be configured to enable the edge operation mode and thus operate as an edge router for ICN and/or IP packets. Other operation modes can also be implemented by the service core, such as autonomous modes, centrally controlled modes, and/or hybrid modes.

The service core can provide a client management service. The client management service can support network client mobility between network devices (e.g., a mobile network client, such as a smart phone, tablet computer, laptop, or another type of network-connected computing device can move from one network device to another network device, such as when moving between wireless networks). The service core can also provide a cache management service. The cache management service can support cache lookup operations and cache update operations.

Additional integrated network architecture components, layers, and services can be provided, as described elsewhere herein.

### Example 2—Integrated Network Architecture Packet Core and Service Core

In any of the examples herein, an integrated network architecture can support information centric networking services (e.g., content delivery services, such as those provided within a content delivery network (CDN)) and/or IP networking services.

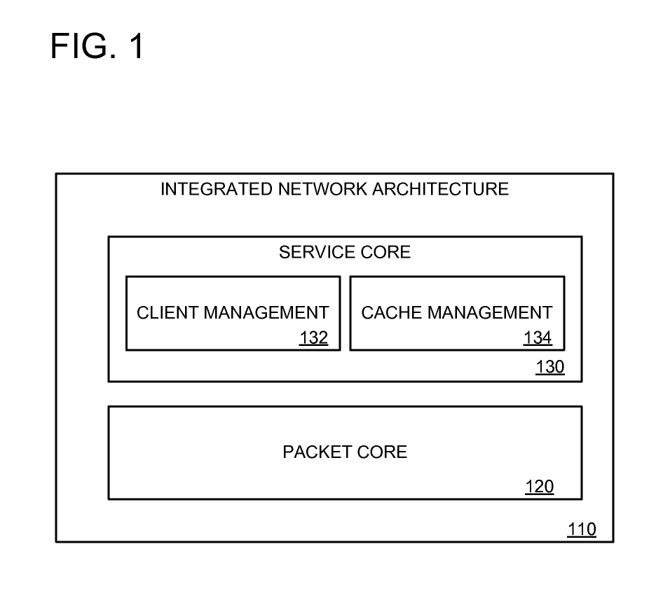

FIG. 1 depicts components of an example integrated network architecture 110. The example integrated network architecture 110 can be implemented by a network device (e.g., network element), such as a router.

The integrated network architecture 110 comprises a packet core 120. The packet core can support packet processing for information centric network (ICN) packets and Internet Protocol (IP) packets core.

The integrated network architecture 110 also comprises a service core 130. The service core can support a plurality of different operation modes. For example, the operation modes can comprise an access operation mode, an edge operation mode, a core operation mode, and a proxy operation mode.

The service core 130 comprises a client management module 132 and a cache management module 134. The client management module 132 can support network client mobility between network devices. The cache management module 134 can support cache lookup services and/or cache update services. For example caching services enable content to be cached through the network resulting in significantly improved efficiencies in content delivery.

The service core 130 can comprise a collection of service functions, including a direct application programming interface (API) service function and an event handler service function. One of the event handlers can be configured to process different types of network packets based on signature information (e.g., to process IP and/or ICN packets). For example, the event handler can be configured to call an IP protocol stack based on a signature of an incoming packet indicating an IP packet type and call an ICN protocol stack based on a signature of an incoming packet indicating an ICN packet type. Other types of network packets can also be processed depending on their packet types.

The service core 130 can also comprise a service core controller. The service core controller can process internal and external events for the integrated network architecture 110 and supports a plurality of event handlers to handle all internal and external events for the integrated network architecture 110 (e.g., packet events, routing events, client and link management events, monitoring events, etc.).

The service core 130 can also support client mobility. For example, the client management service 132 can provide for attachment, detachment, and authentication of network client devices (e.g., mobile computing devices, such as smart phones, tablet computers, and other mobile network clients). The client management service 132 can also authenticate network clients (e.g., prior to attachment). The client management service 132 can also monitor the state of connected network clients (e.g., as active or inactive) and disconnect clients if needed (e.g., if a network client has been inactive for a period of time).

In a specific implementation, the client management service 132 provides for client mobility by receiving a request from a client to move from a first network device implementing the integrated network architecture 110 (e.g., a first router) to a second network device implementing the integrated network architecture 110 (e.g., a second router). In response, the client management service 132 (e.g., of the first router) disconnects the network client and forwards traffic to the second network device. When the network client has connected to the second network device, and traffic for the network client has been routed directly to the second network device, and the first network device can stop forwarding.

The client management service 132 can also be configured to control access to content. For example, the client management service 132 can control access to content based on the identity of the content, the identity of the network client trying to access the content, and/or the privileges associated with the network client.

The service core 130 can be configured to detect anomalies and use the client management service 132 to handle the same. For example, the anomalies can include detection of denial-of-service attacks.

The integrated network architecture 110 can also comprise an application services component. The application services component provides services such as search services, application specific routing services, and other types of services. For example, a search service can be provided to support searching for content in the information centric network. An application specific routing service can be provided for supporting routing in the IP/ICN network based on application types, such as a multimedia type.

### Example 3—Integrated Network Architecture Functions

In any of the examples herein, an integrated network architecture can provide one or more of the following functions. The functions provided by the integrated network architecture are generally classified as platform functions, deployment specific functions, service specific functions, and management and control functions.

Platform Functions. Platform functions provide foundation capabilities on top of which the other functions can be built. Platform functions can include:
Memory management
Queue management
Communication services
Filtering and matching services
Route table management
Packet forwarding
Authentication services
Packet level encryption and decryption
Layer 2 services for supported networks
Layer 1 services for supported networks
Framework services for management (management protocols and management interfaces, such as console, command line interface (CLI), and web)

Deployment Specific Functions. The integrated network architecture can provide various network functions at different locations in the network. For example, the integrated network architecture can be configured to provide access functions, core functions, edge functions, proxy functions, and/or other network functions. Also, some of the functions (e.g., forwarding, caching, DoS/DDoS detection, etc.) can be performed in any of the network devices, independent of the device's deployment role.

A network device (e.g., a router) that implements the integrated network architecture can be configured as an access node. An access node can provide entry points into a network where network clients can attach to the network. For example, access nodes can provide one or more of the following capabilities (e.g., in addition to standard routing/switching functions):
Attachment/detachment of clients (e.g., client can be directly attached to an access node or attached via intermediary devices, such as legacy routers or switches)
Mobility Management (e.g., for clients that are mobile and need to attach/detach to different access nodes across the network)
Verification (e.g., to determine whether a client is authorized for specific services)
Rogue node identification (e.g., detection of rogue clients based on traffic patterns, such as patterns indicating a denial-of-service or distributed denial-of-service attack)

A network device (e.g., a router) that implements the integrated network architecture can be configured as a core node. A core node can be primarily responsible for moving packets through the network. In addition, a core node can also operate as a caching node (e.g., in a content delivery network). For example, a core node can provide one or more of the following capabilities:
High scalability—ability to support extremely high traffic at wire speed
Ability to support IP and ICN based routing at wire speed

A network device (e.g., a router) that implements the integrated network architecture can be configured as an edge node. An edge node can act as an interconnect point between two (or more) different network domains and control inter-domain traffic. For example, an edge node can provide one or more of the following capabilities:
Inter-domain routing and traffic control
Monitoring and management of interconnects (e.g., links between different network domains)
Tunneling services (for e.g. tunneling ICN traffic through IP-only networks)
Session Border Controller (SBC) functions (e.g., enabling secure exchange of information across domains)
Inter-domain trust management

A network device (e.g., a router) that implements the integrated network architecture can be configured as a proxy node. A proxy node can enable networking across different network types. For example, a proxy node can enable translation of IP based packets to corresponding ICN based packets when traversing from an IP network to an ICN network and vice-versa. For example, a proxy node can provide one or more of the following capabilities:
Message translation
Request termination and re-routing
Request load balancing

Service Specific Functions. The integrated network architecture can provide various service specific functions to support different network types. For example, the integrated network architecture can be configured to ICN specific service functions (e.g., in addition to or instead of traditional IP routing functions). For example, one or more of the following ICN related service specific functions can be provided:
Support for request-response traffic models (e.g., where the response to a request is routed via the same path as the request)
Name based routing
Network wide content state management
Cache lookup and resolution
Request authentication
Response verification
Multi-path routing
Request aggregation and forwarding
Physical and virtual link management between adjacent ICN nodes
IP-ICN Request Translation
ICN-IP Response Translation

Management and Control Functions. The integrated network architecture can provide various management and control functions. The various management and control functions can support different operating environments from centralized environments to decentralized or hybrid environments. For example, one or more of the following management and control functions can be provided:
Dynamic control of routing policies and routing decisions
Dynamic control of caching policies
Dynamic update of network specific security parameters
Dynamic update of content state in the network

Application Services. The integrated network architecture can provide application services. For example, application services can be used to extend core routing functions to enable new applications and services to be deployed by network devices implementing the integrated network architecture.

Application services can provide specialized processing of multimedia packets. For example, such specialized processing can enable prioritized routing, run-time transcoding, and other multimedia services (e.g., in addition to basic routing services).

Application services can provide search services. For example, search engines can use the search service to efficiently discover content in an information centric network. In addition, name based routing can be provided to support attributed based and/or similarity based search. For example, if a request is received to search for images similar to a specific image, a similarity analysis can be performed on the content available at the network device (e.g., from a local cache) to retrieve matching images.

Application services can provide application specific routing. Application specific routing can enable a new class of services that leverage ICN capabilities for more efficient functioning. For example, traditional enterprise service bus functionality can be moved onto the network by providing subscribe-notify capabilities. In addition, features of an enterprise service bus, such as complex attribute matching, can be implemented as application level services while notification can be achieved efficiently through multi-path routing.

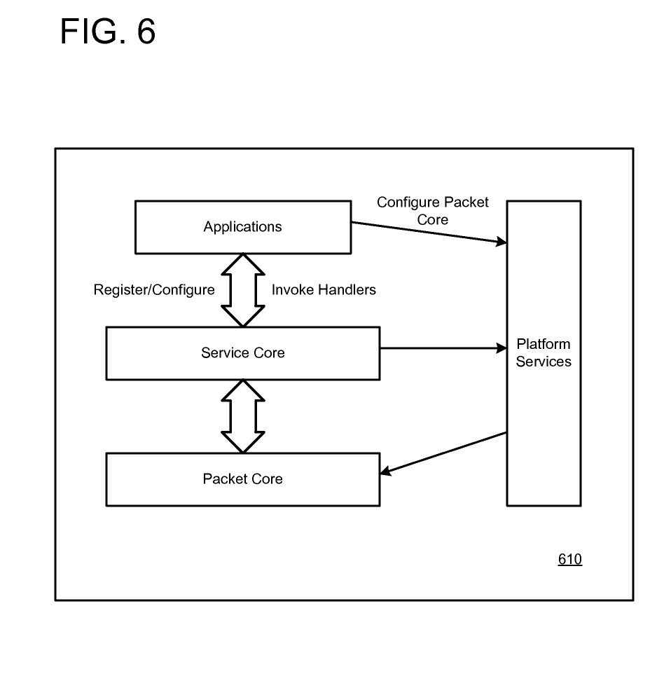

The integrated network architecture can provide application specific extensions by registering packet handlers to take control of routing of individual packets (e.g., using application programming interfaces (APIs). FIG. 6 depicts an example implementation for application specific extensions 610. In the example implementation for application specific extensions 610, applications can register and configure packet handlers (e.g., with a service core and/or packet core). A routing service can then invoke the appropriate application handlers when a matching packet arrives. The application can do additional packet processing as well as configure the packet core (e.g., for privileged forwarding of flows that match a specific signature). For example, a real-time communication service can register to receive real-time protocol (RTP) packets and upon receiving the first packet, define the corresponding flow (e.g., based on source-destination nodes) using the packet core with the necessary priorities.

### Example 4—Network Domains

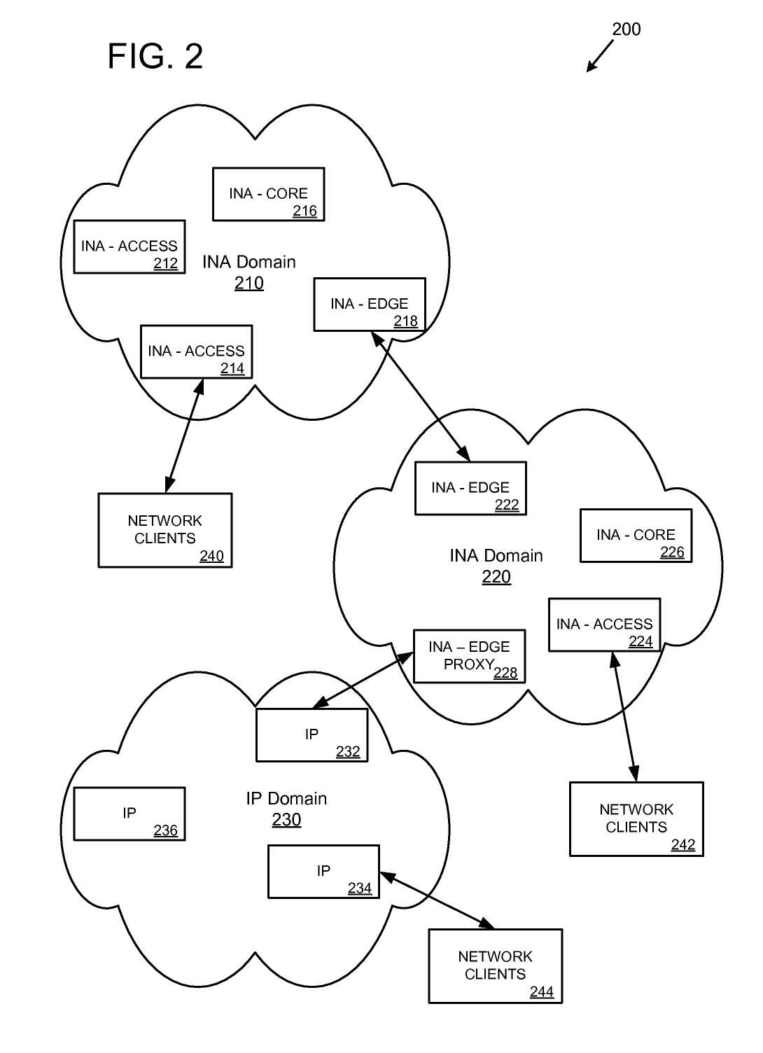

FIG. 2 is a diagram of example network domains 200, including INA domains and IP domains. FIG. 2 provides a simplified example of how the integrated network architecture can be used to provide ICN and IP functionality in a combined networking environment.

In the example domains 200, there are two INA enabled domains 210 and 220. The INA enabled domains 210 and 220 can support ICN functionality, separately or in combination with IP functionality.

The INA enabled domains 210 and 220 comprise INA network devices (e.g., routers) in a variety of roles. For example, INA domain 210 includes INA devices providing client access 212 and 214 (access nodes). The INA access nodes 212 and 214 support connections from network clients, such as network clients 240. The INA domain 210 also includes a core node 216, which can route information within the INA domain 210. The INA domain 210 also includes an edge node 218, which can provide communication between the INA domain and other domains, such as INA domain 220.

The INA domain 220 communicates to INA domain 210 via edge node 222. The INA domain 220 also comprises a core node 226, an access node 224 (for providing network access to network clients 242), and an edge proxy node 228. The edge proxy node 228 can provide an interconnection between the INA domain 220 and other types of domains, such as IP domain 230.

The IP domain 230 can represent a traditional IP domain (e.g., a domain that does not provide information centric networking services). The IP domain 230 includes IP network devices 232, 234, and 236 (e.g., IP routers). The IP domain 230 also provides network access to network clients 244.

### Example 5—Integrated Network Architecture Details

In any of the examples herein, an integrated network architecture can support information centric networking services (e.g., content delivery services) and/or IP networking services.

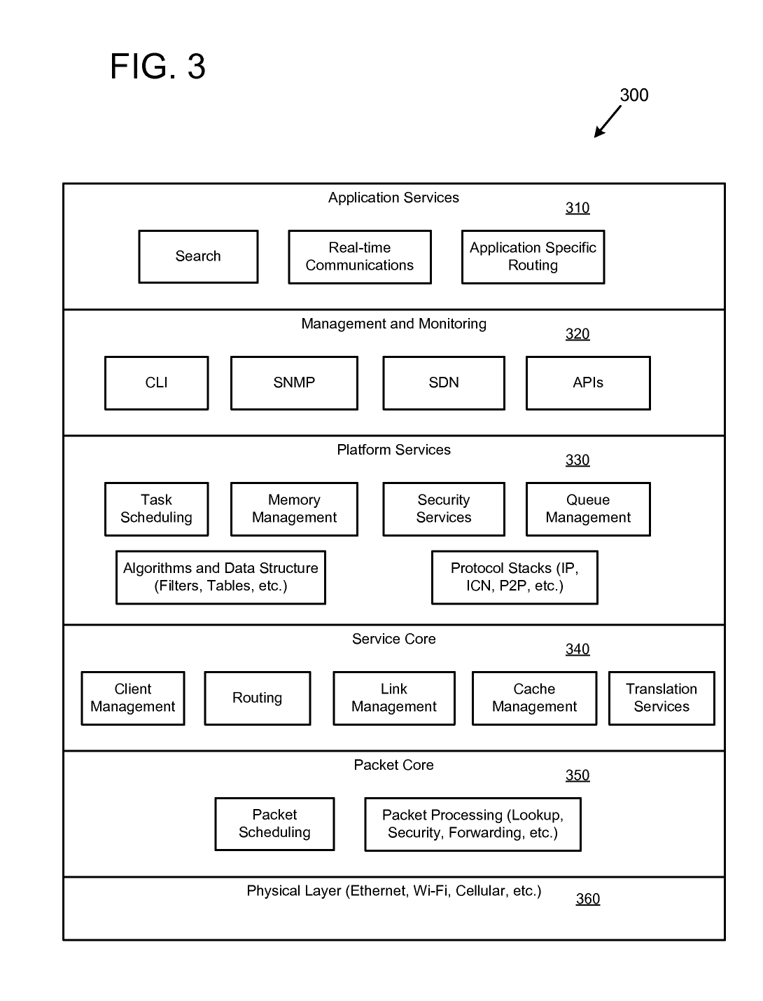

FIG. 3 depicts components of an example integrated network architecture 300 with multiple layers. The example integrated network architecture 300 can be implemented by a network device (e.g., network element), such as a router. The example integrated network architecture 300 can provide platform functions, deployment specific functions, service specific functions, and management and control functions.

The example integrated network architecture 300 can be configured to provide network services in a variety of roles (e.g., by enabling or disabling various components of the architecture). For example, the example integrated network architecture 300 can provide core functions, access functions, edge functions, proxy functions, and/or other network functions.

The architecture 300 includes a physical layer 360 (e.g., providing connectivity to various physical network types, such as Ethernet, Wi-Fi, cellular, etc.), a packet core layer 350, a service core layer 340, a platform services layer 330, a management and monitoring layer 320, and an application services layer 310.

The packet core layer 350 of the architecture 300 can be responsible for enabling wire speed processing of incoming and outgoing packets. For example, the packet core layer 350 can provide packet scheduling functions. Packet scheduling functions can include deciding whether a packet can be switched directly (e.g., without having to be processed by higher layers). For example, packet scheduling can include signaling a higher layer for those packets that cannot be directly switched by the packet core layer 350.

The packet core layer 350 can provide packet processing functions. Packet processing can be performed on packets based on their signature (e.g., prefix matching filters for IP packet types, ICN packet types, and/or other packet types), and can include:
Lookup functions to identify destination ports through which packets are to be sent out
Authentication
Encryption and decryption
Packet forwarding (e.g., supporting simple forwarding (e.g., for IP packets) as well as request and response forwarding (e.g., for ICN packets))
Support for configuration of switching behavior for different packet signatures
Support for configuration of multiple packet processing modules (e.g., a module can refer to a combination of specific packet processing functions that are triggered when a packet of a specific signature is received)
Support for explicit invocation of packet processing modules by higher layers

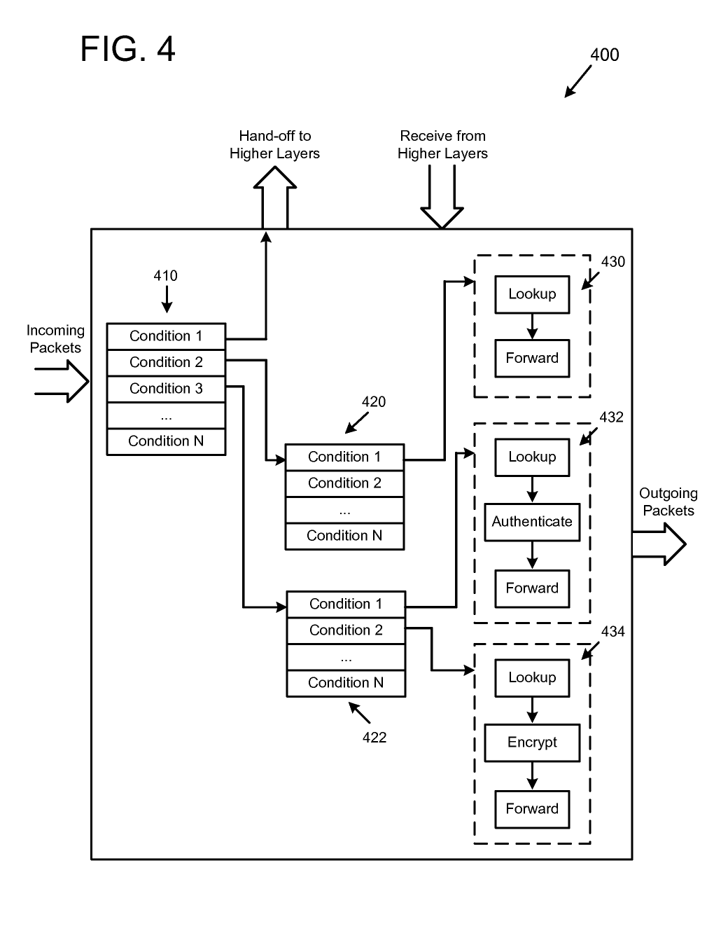

FIG. 4 is a diagram depicting example packet core processing 400 that can be performed by a packet core layer (e.g., by packet core layer 350) of the integrated network architecture. The packet core processing 400 implements a hierarchical processing model. For example, the hierarchical processing model can begin with network type identification (e.g., IP or ICN), and continue with signature matching and trigger of appropriate packet processing modules.

In the example packet core processing 400, incoming packets are processed according to a first set of conditions 410. For example, the first set of conditions 410 can distinguish between IP network packets and ICN network packets. After the first set of conditions 410, a second set of conditions are applied 420 and 422. For example, the second set of conditions can comprise conditions for processing IP network packets (e.g., 420) and other conditions for processing ICN network packets (e.g., 422). Other conditions can also be applied. For example, conditions can be applied based on other types of network packets. In addition, conditions can be organized into additional hierarchical levels.

Based on the conditions, packet processing operations can be performed. For example, if an IP network packet is detected (e.g., “Condition 2” at 410), it can be processed based on conditions 420. For example, if “Condition 1” at 420 is satisfied, then the packet can be processed according to operations 430 (e.g., typical IP destination lookup and forward operations for an IP packet).

As another example, if an ICN packet is detected (e.g., “Condition 3” at 410), it can be processed based on conditions 422. For example, if “Condition 1” at 422 is satisfied, then the packet can be processed according to operations 432 (e.g., network client lookup, authentication, and forward operations can be performed). Similarly, if “Condition 2” at 422 is satisfied, then the packet can be processed according to operations 434.

If certain conditions are satisfied, then packets can be sent to higher layers for processing (e.g., if “Condition 1” at 410 is satisfied). For example, application specific processing of packets can be performed at higher layers of the integrated network architecture.

The service core layer 340 can comprise a collection of services that can be enabled, disabled, configured, and combined based on deployment details. For example, different services can be provided based on the role of the network device implementing the architecture (e.g., access node, edge node, core node, proxy node, etc.).

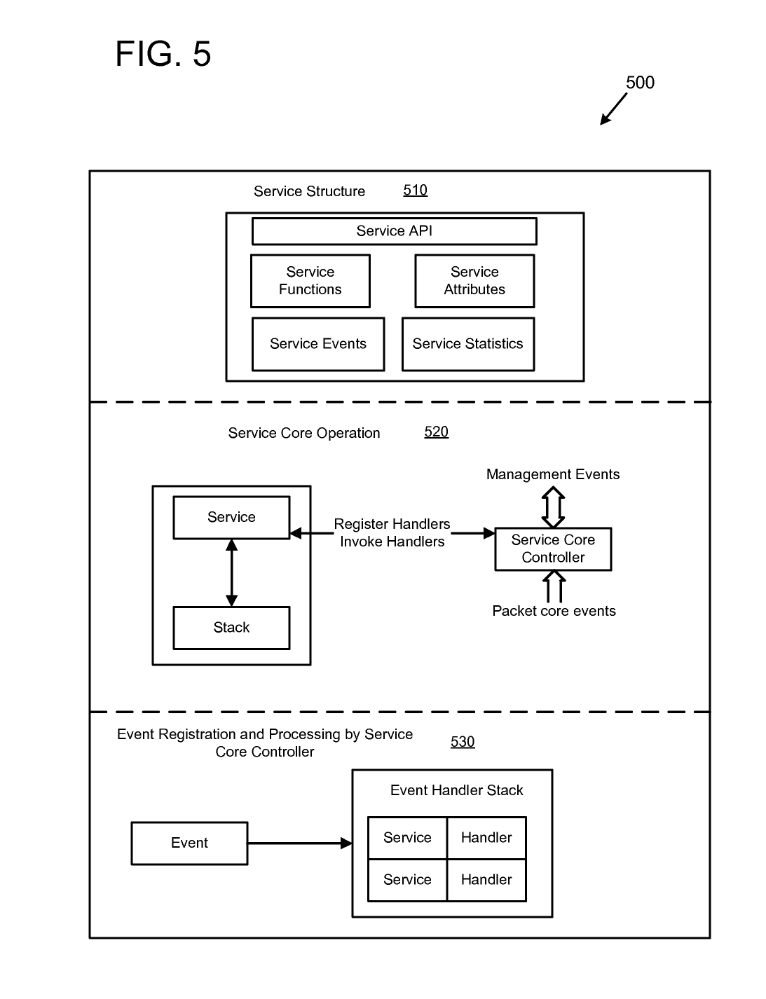

FIG. 5 is a diagram depicting example elements and operation of a service core 500 (e.g., depicting operation of the service core layer 340 in more detail) of the integrated network architecture. The example service core 500 includes service structure 510 elements, service core operation 520, and event registration and processing 530.

The Service core layer 340 provides a number of services, where each service can include a group of related operations or functions. Services can be controlled and configured via service attributes. A service can also generate events related to a run-time state. Service operations or functions can be invoked in a number of ways. For example, service operations or functions can be invoked via direct application programming interface (API) calls (e.g., provided by the service structure 510). This is the typical way that application services and the management and monitoring layer (e.g., 320) can interact with services. The direct API can provide for operations such as:
Configuration and setup
Monitoring (e.g., statistics collection)
Setup of application layer handlers to enable run-time handling of incoming packets

Service operations or functions can also be invoked via event handlers (e.g., provided by the service core operation layer 520). With event handlers, a service registers with the service core controller or its corresponding protocol stacks for events it is interested in and can process. When such events are encountered, the controller invokes the appropriate service handlers. Typical events can include:
Events from the packet core 350 (e.g., incoming packet of a specific signature)
Management events (e.g., run-time control or re-configuration requests)
Events from other services

Each service can operate independently and is not directly dependent on other services. Any run-time dependencies can be handled by events.

The service core controller (e.g., provided by the service core operation layer 520) can control run-time processing performed by the service core 340. The service core can be designed as an event-driven system with the service core controller being the single point of entry for internal and external events. Services can register with events of interest, and multiple handlers can register for a single event. If multiple handlers are registered, then the service core controller can prioritize access by the handlers.

The service core controller can receive events from the packet core 350. For example, incoming packets that are not handled directly by the packet core can be handed off to the service core. The service core controller can identify the right handler to process such packets, and the following procedure can be used:
Service core controller receives a packet-in event along with packet signature
Based on the signature, the service core controller invokes the appropriate stack (e.g., IP or ICN)
The protocol stack invokes the appropriate service handler based on the packet signature and the related handler registered by a service

The service core controller can receive events from, or publish events to, the management and monitoring layer 320. Event processing depends on the handlers registered by the different services. In some implementations, the services are expected to support a set of standard control events, such as start, shutdown, pause, and resume. The sequence in which such events are handled can be configured by the management and monitoring layer using the service core interface.

The management and monitoring layer 320 can provide one or more of the following functions:
Provides standards based interfaces for external management applications to control the INA enabled network device (network element (NE))
Provides services to setup all components of the network device
Manages the end-to-end life cycle of all network device components
Monitors the state and statistics of all network device components and regularly updates external management applications
Aggregates statistics from different components and presents a user friendly summary to external management application
Listens for alarms from within the network device, recovers from the alarm, and propagates alarm information to external management applications
Enables on-demand statistics related to traffic flowing through the network device
Supports dynamic re-configuration of the network device without service disruption
Supports software-defined networking (SDN)
Supports simple network management protocol (SNMP)

Within the service core controller, services can handle events published by other services. For example, in an access router, ICN requests from a specific network client can be processed only after the network client is successfully attached to the router. This can be achieved by enabling processing of requests from the network client only after a “new_client_attached” event (e.g., published by the client management service) is received.

The service core layer 340, and related service core detail 500, can provide powerful capabilities enabling deployment of a network device implementing the integrated network architecture in a variety of roles (e.g., access, core, edge, proxy, autonomous, centralized, hybrid, etc.) by appropriately configuring the service core elements of the network element.

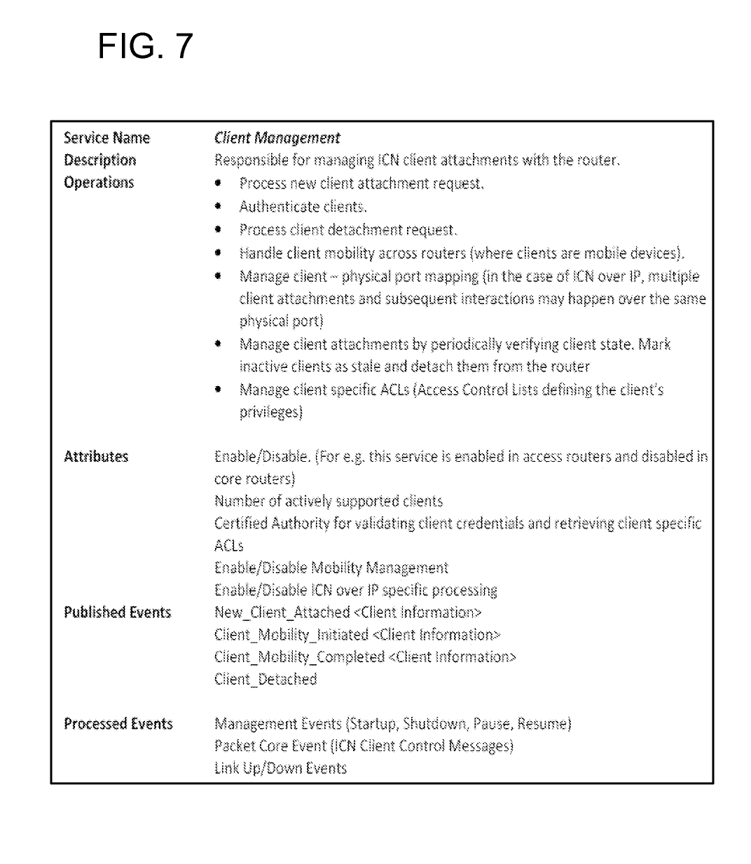

The service core layer 340 can provide a client management service. In a specific implementation, the client management service is defined by the operations, attributes, published events, and process events depicted in FIG. 7.

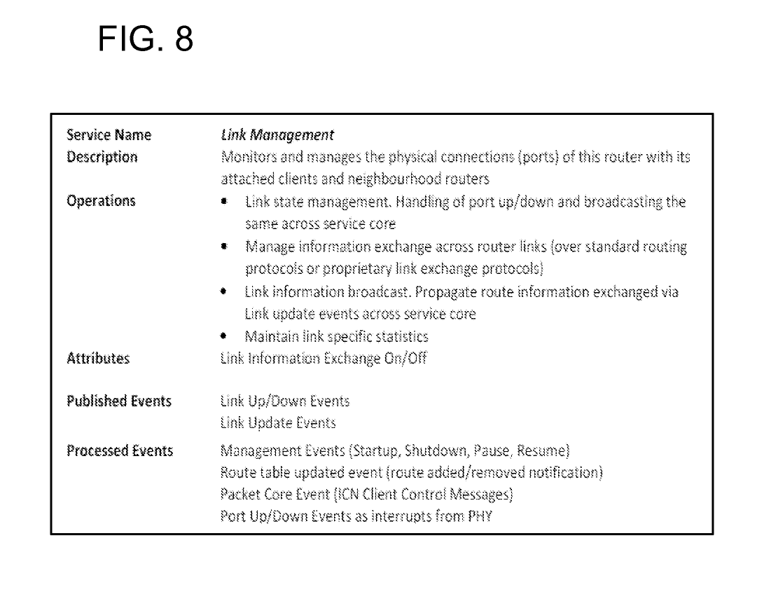

The service core layer 340 can provide a link management service. In a specific implementation, the link management service is defined by the operations, attributes, published events, and process events depicted in FIG. 8.

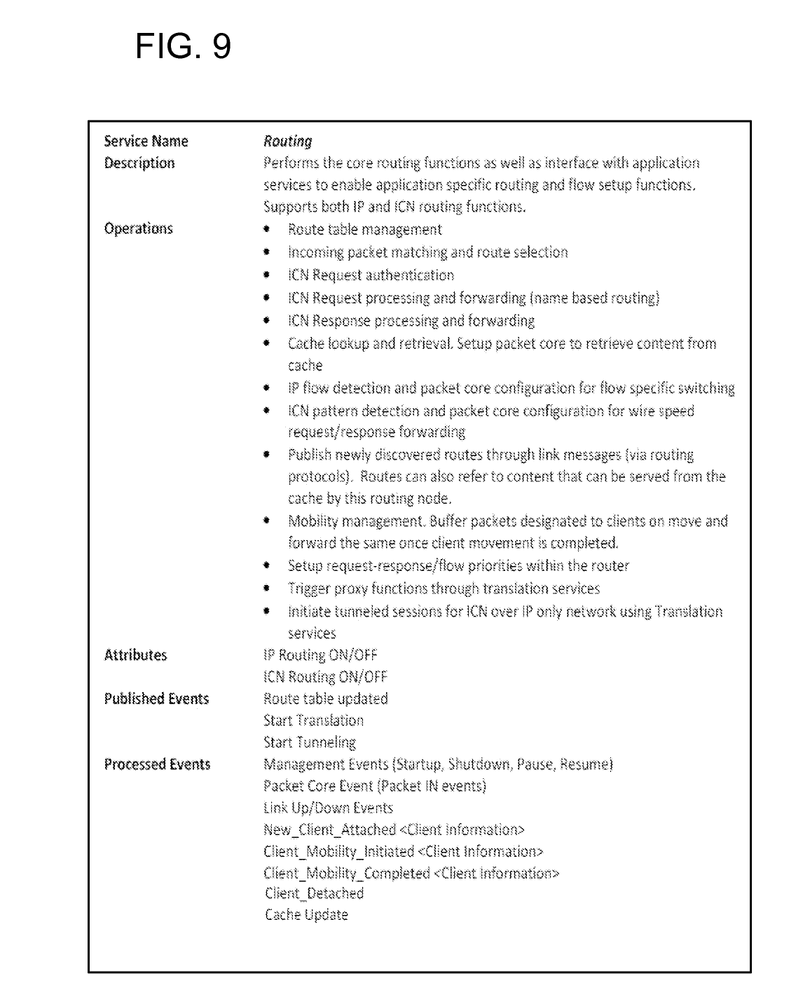

The service core layer 340 can provide a routing service. In a specific implementation, the routing service is defined by the operations, attributes, published events, and process events depicted in FIG. 9.

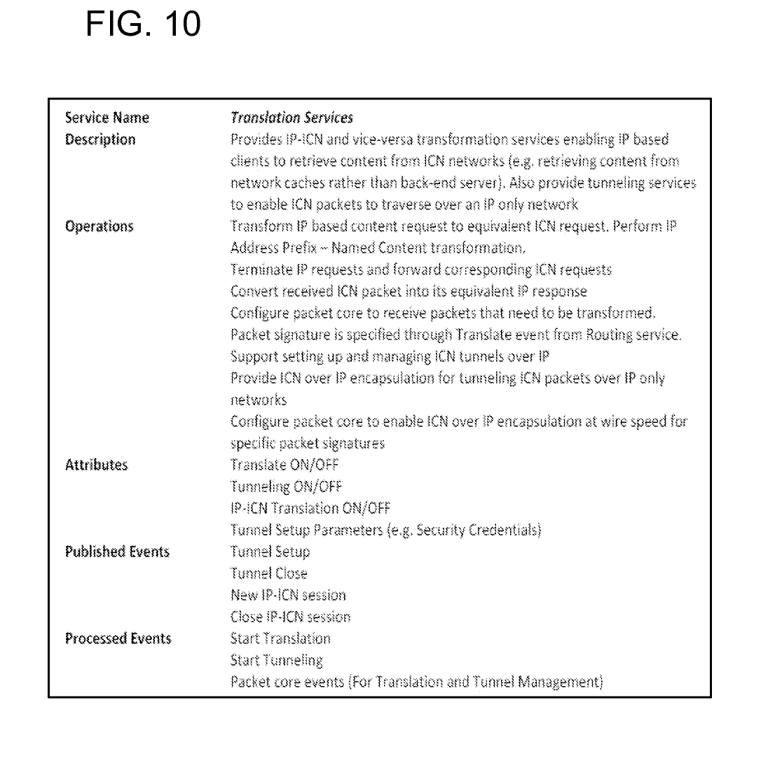

The service core layer 340 can provide a translation service. In a specific implementation, the translation service is defined by the operations, attributes, published events, and process events depicted in FIG. 10.

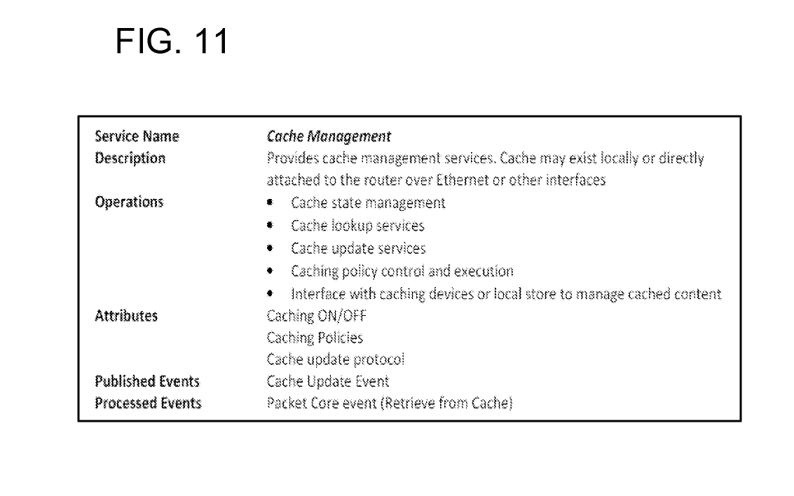

The service core layer 340 can provide a cache management service. In a specific implementation, the cache management service is defined by the operations, attributes, published events, and process events depicted in FIG. 11.

### Example 6—Exemplary Computing Systems

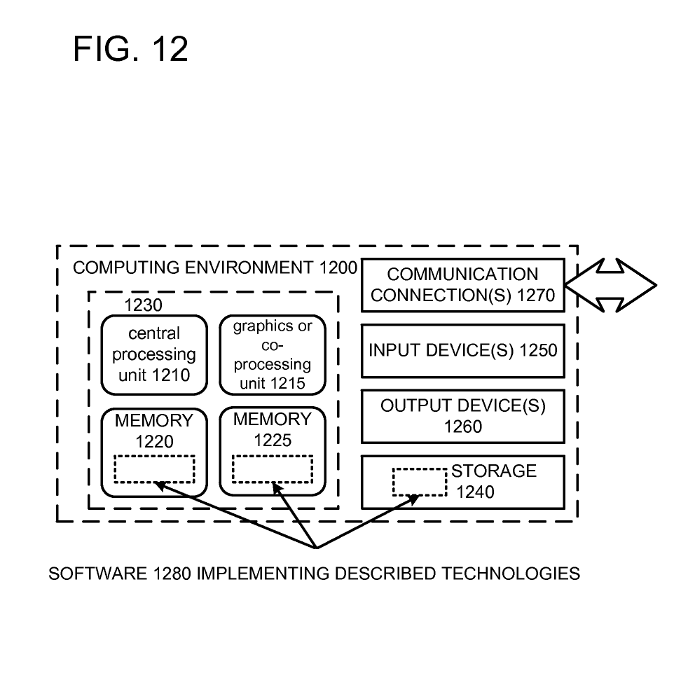

FIG. 12 depicts a generalized example of a suitable computing system 1200 in which the described innovations may be implemented. The computing system 1200 is not intended to suggest any limitation as to scope of use or functionality, as the innovations may be implemented in diverse general-purpose or special-purpose computing systems.

With reference to FIG. 12, the computing system 1200 includes one or more processing units 1210, 1215 and memory 1220, 1225. In FIG. 12, this basic configuration 1230 is included within a dashed line. The processing units 1210, 1215 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 12 shows a central processing unit 1210 as well as a graphics processing unit or co-processing unit 1215. The tangible memory 1220, 1225 may be volatile memory (e.g., registers, cache, RAM), non-volatile memory (e.g., ROM, EEPROM, flash memory, etc.), or some combination of the two, accessible by the processing unit(s). The memory 1220, 1225 stores software 1280 implementing one or more innovations described herein, in the form of computer-executable instructions suitable for execution by the processing unit(s).

A computing system may have additional features. For example, the computing system 1200 includes storage 1240, one or more input devices 1250, one or more output devices 1260, and one or more communication connections 1270. An interconnection mechanism (not shown) such as a bus, controller, or network interconnects the components of the computing system 1200. Typically, operating system software (not shown) provides an operating environment for other software executing in the computing system 1200, and coordinates activities of the components of the computing system 1200.

The tangible storage 1240 may be removable or non-removable, and includes magnetic disks, magnetic tapes or cassettes, CD-ROMs, DVDs, or any other medium which can be used to store information in a non-transitory way and which can be accessed within the computing system 1200. The storage 1240 stores instructions for the software 1280 implementing one or more innovations described herein.

The input device(s) 1250 may be a touch input device such as a keyboard, mouse, pen, or trackball, a voice input device, a scanning device, or another device that provides input to the computing system 1200. For video encoding, the input device(s) 1250 may be a camera, video card, TV tuner card, or similar device that accepts video input in analog or digital form, or a CD-ROM or CD-RW that reads video samples into the computing system 1200. The output device(s) 1260 may be a display, printer, speaker, CD-writer, or another device that provides output from the computing system 1200.

The communication connection(s) 1270 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Example 7—Exemplary Cloud Computing Environment

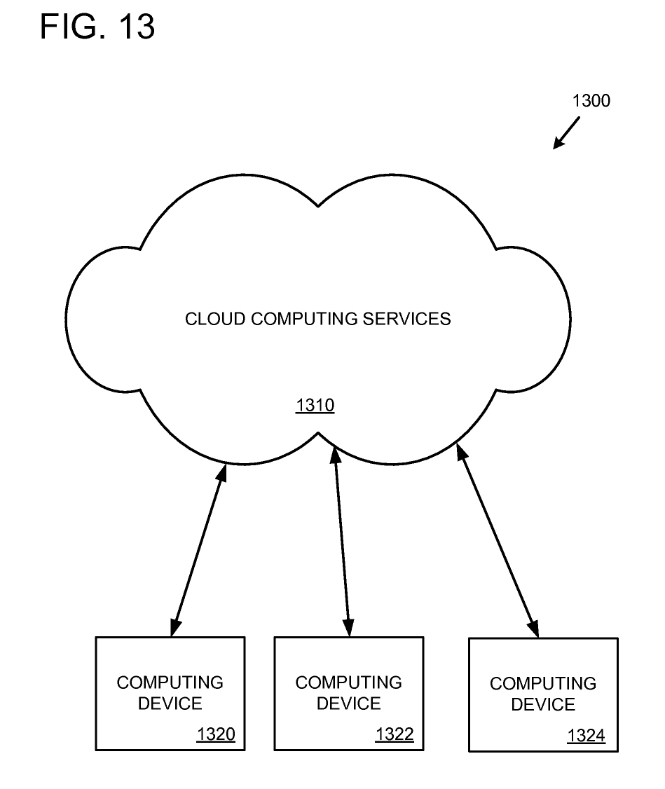

FIG. 13 depicts an example cloud computing environment 1300 in which the described technologies can be implemented. The cloud computing environment 1300 comprises cloud computing services 1310. The cloud computing services 1310 can comprise various types of cloud computing resources, such as computer servers, data storage repositories, networking resources, etc. The cloud computing services 1310 can be centrally located (e.g., provided by a data center of a business or organization) or distributed (e.g., provided by various computing resources located at different locations, such as different data centers and/or located in different cities or countries).

The cloud computing services 1310 are utilized by various types of computing devices (e.g., client computing devices), such as computing devices 1320, 1322, and 1324. For example, the computing devices (e.g., 1320, 1322, and 1324) can be computers (e.g., desktop or laptop computers), mobile devices (e.g., tablet computers or smart phones), or other types of computing devices. For example, the computing devices (e.g., 1320, 1322, and 1324) can utilize the cloud computing services 1310 to perform computing operators (e.g., data processing, data storage, and the like).

### Example 8—Exemplary Implementations

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (e.g., any available computing device, including smart phones or other mobile devices that include computing hardware). Computer-readable storage media are any available tangible media that can be accessed within a computing environment (e.g., non-transitory computer-readable media, such as one or more optical media discs such as DVD or CD, volatile memory components (such as DRAM or SRAM), or nonvolatile memory components (such as flash memory or hard drives)). By way of example and with reference to FIG. 12, computer-readable storage media include memory 1220 and 1225, and storage 1240. As should be readily understood, the term computer-readable storage media does not include communication connections (e.g., 1270) such as modulated data signals.

Any of the computer-executable instructions for implementing the disclosed techniques as well as any data created and used during implementation of the disclosed embodiments can be stored on one or more computer-readable storage media (e.g., non-transitory computer-readable media). The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

### Alternatives

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the following claims. We therefore claim as our invention all that comes within the scope and spirit of the claims.

We claim:

1. An integrated network architecture, implemented at least in part by a network device, for providing information centric and Internet Protocol processing, the network architecture comprising:
a packet core, wherein the packet core supports packet processing for information centric network (ICN) packets and Internet Protocol (IP) packets;
a service core, wherein the service core comprises services supporting a plurality of different operation modes, wherein the plurality of different operation modes comprise an access operation mode, an edge operation mode, a core operation mode, and a proxy operation mode, and wherein the service core supports independent enabling or disabling of each of the plurality of operation modes;
a client management service, provided by the service core, wherein the client management service supports network client mobility between network devices; and
a cache management service, provided by the service core, wherein the cache management service supports cache lookup and cache update services.

2. The network architecture of claim 1 wherein the network architecture provides ICN services and IP network services.

3. The network architecture of claim 1 wherein the service core comprises:
a collection of service functions, wherein the service functions comprise a direct application programming interface (API) service function and an event handler service function, and wherein the service functions further comprise an event handler configured to:
call an IP protocol stack based on a signature of an incoming packet indicating an IP packet type; and
call an ICN protocol stack based on a signature of an incoming packet indicating an ICN packet type.

4. The network architecture of claim 1 wherein the service core comprises:
a service core controller, wherein the service core controller processes internal and external events for the network architecture and supports a plurality of event handlers.

5. The network architecture of claim 1 wherein the client management service supports client attachment, client detachment, and client authentication for network clients.

6. The network architecture of claim 1 wherein the client management service is configured to determine a state of a client, wherein the state of the client is one of active and inactive, and wherein the client management service supports disconnecting clients that are inactive.

7. The network architecture of claim 1 wherein the client management service is configured to:
control access to specific content based on an identity of a network client and based on privileges of the network client for accessing the specific content; and
detect anomalies, wherein the anomalies comprise denial-of-service attacks.

8. The network architecture of claim 1, further comprising:
an application services component, wherein the application services component provides services comprising:
a search service, wherein the search service supports searching for content in the information centric network; and
an application specific routing service that supports routing in the information centric network based on application types, wherein the application types include a multimedia type.

9. The network architecture of claim 1, wherein the packet core is configured to perform packet processing operations depending on packet signature, including IP packet signatures and ICN packet signatures, and wherein the packet core is further configured to:
perform packet forwarding for IP packets; and
perform request and response forwarding for ICN packets.

10. An network device implementing an integrated network architecture for providing information centric and Internet Protocol processing, the network device comprising:
one or more processing units;
one or more network adaptors; and
memory;
wherein the network device is configured to provide network components comprising:
a packet core, wherein the packet core supports packet processing for information centric network (ICN) packets and Internet Protocol (IP) packets;
a service core, wherein the service core comprises services supporting a plurality of different operation modes, wherein the plurality of different operation modes comprise an access operation mode, an edge operation mode, a core operation mode, and a proxy operation mode, and wherein the service core supports independent enabling or disabling of each of the plurality of operation modes;
a client management service, provided by the service core, wherein the client management service supports client mobility between network devices; and
a cache management service, provided by the service core, wherein the cache management service supports cache lookup and cache update services.

11. The network device of claim 10 wherein the network device provides ICN services and IP network services.

12. The network device of claim 10 wherein the service core comprises:
a collection of service functions, wherein the service functions comprise a direct application programming interface (API) service function and an event handler service function;
wherein the service core is configured to:
call a first event handler for handling IP packets based on a signature of an incoming packet indicating an IP packet type; and
call a second event handler for handling ICN packets based on a signature of an incoming packet indicating an ICN packet type.

13. The network device of claim 10 wherein the service core comprises:
a service core controller, wherein the service core controller processes internal and external events for the network device and supports a plurality of event handlers.

14. The network device of claim 10 wherein the client management service supports client attachment, client detachment, and client authentication for network clients.

15. The network device of claim 10 wherein the client management service is configured to determine a state of a client, wherein the state of the client is one of active and inactive, and wherein the client management service supports disconnecting clients that are inactive.

16. The network device of claim 10 wherein the client management service is configured to control access to specific content based on an identity of a network client and based on privileges of the network client for accessing the specific content.

17. The network architecture of claim 10 wherein the client management service is configured to detect anomalies, wherein the anomalies comprise denial-of-service attacks.

18. The network device of claim 10, wherein the network components further comprise:
an application services component, wherein the application services component provides services comprising:
a search service, wherein the search service supports searching for content in the information centric network; and
an application specific routing service that supports routing in the information centric network based on application types, wherein the application types include a multimedia type.

19. An integrated network architecture, implemented at least in part by a network device, for providing information centric and Internet Protocol (IP) processing within a combined information centric network (ICN) and IP network, the network architecture comprising:
a packet core, wherein the packet core supports packet processing for information centric network (ICN) packets and IP packets;
a service core, wherein the service core comprises services supporting a plurality of different operation modes, wherein the plurality of different operation modes comprise an access operation mode, an edge operation mode, a core operation mode, and a proxy operation mode, and wherein the service core supports independent enabling or disabling of each of the plurality of operation modes;
a client management service, provided by the service core, wherein the client management service supports client mobility between network devices; and
a cache management service, provided by the service core, wherein the cache management service supports cache lookup and cache update services;
a routing service, provided by the service core, wherein the routing service supports routing for ICN packets and IP packets;
a translation service, provided by the service core, wherein the translation service supports translating between ICN information and IP information;
a link management service, provided by the service core, wherein the link management service supports communication between network devices of the combined ICN and IP network; and
an application services component, wherein the application services component provides services comprising search services and application specific routing services.

20. The network architecture of claim 19, further comprising:
a management and monitoring component, wherein the management and monitoring component provides services including statistics and alert monitoring.
